(19) United States
(12) Patent Application Publication
(10) Pub. No.: US 2021/0237526 A1
(43) Pub. Date: Aug. 5, 2021

(54) Autonomous Vehicles that Operate on Roads or Monorails

(71) Applicant: Thomas Holtzman Williams, Longmont, CO (US)

(72) Inventor: Thomas Holtzman Williams, Longmont, CO (US)

(21) Appl. No.: 16/780,015

(22) Filed: Feb. 3, 2020

(51) Int. Cl. B60F 1/04

(52) U.S. Cl. CPC B60F 1/04

(57) ABSTRACT

Described is a multi-mode transportation system with roads and monorails, and vehicles that can transform to travel on either roads, or monorails, or on both simultaneously. Vehicles move in mode 1 on the roads using road wheels that roll over pavement. Vehicles in mode 2 move on the monorails and are supported by rail wheels in contact with a top of a monorail. In mode 2, the vehicle is supported by side cylinders that stabilize the vehicle on the monorail. Vehicles move in mode 3 with support from both roads and monorails simultaneously. Monorail mount locations simplify the vehicle's transition between modes. Pivoting or other mechanisms for road wheels, rail wheels, or side cylinders facilitate vehicle design. The vehicle can optionally be connected to the Internet, and be part of a traffic control system or operate autonomously. Small scale models or computer models of these vehicle can be used as toys, for product development, prototyping, animation, competitive games, entertainment, or for education.

### CROSS REFERENCE TO RELATED APPLICATIONS

This application claims benefit and priority of US Provisional Patent Application Ser. No U.S. 62/918,544 filed Feb. 4, 2019. The disclosures of this application are incorporated herein by reference in their entireties.

### BACKGROUND

There is currently a need for improved transportation worldwide, complicated by high population density and climate change from use of fossil fuels. Rails are an efficient method for transporting people and material due to low rolling resistance on rails, relative to roads. Rails can also have advantages of cheap construction, and have an ability to power the vehicles from electricity flowing through rails. It is also an efficient use of real estate relative to roads. However, traveling on foot potentially relatively long distances from homes or businesses to and from rail terminals is a problem. Disposing of a commuter vehicle after getting to the rail terminal is also a problem, as is procuring another commuter vehicle when getting off of the rail. Bicycles are an efficient mode of transportation and can sometimes be carried on a train, but cannot be used by all commuters and are not suited for inclement weather.

Currently there is an interest in self-driving or automated vehicles. Autonomous vehicles are useful for delivering goods and transporting people. If autonomous vehicles are used in an automatic traffic control system, other advantages accrue, such as route planning, collision avoidance, elimination of traffic signals, stop signs, and higher traffic density.

Self-driving cars are one type of automated vehicle that hold promise for the future, but just add to traffic congestion and environmental damage with essentially the same use of resources (steel, rubber, fuel or electrical energy) as cars with drivers.

Monorails have an advantage over two rail systems of less space required, but bring a problem of balance while on the monorail. Monorail systems are used in several cities essentially as train substitutes. Monorail systems have been built with both overhead and underneath monorails. This invention is primarily directed to having the supporting monorail underneath the vehicle.

It is an object of this invention to make a vehicle that can be driven or operated autonomously (self-driven). When it is operating autonomously, it can be part of a computer-controlled traffic system. This vehicle can operate on a roads, a rail, or both a road and a rail simultaneously. The vehicle can transition between travel modes. Simultaneous operation is used to reduce rolling resistance and to transport heavy loads without road damage.

It is also an object to improve safety while traveling and to reduce fuel and electricity consumption, decreasing the rate of environmental damage, particularly from CO₂. It is also an object of this invention to enable connected cars. It is also an object of this invention to enable transportation as a service, rather than car ownership. It is also an object of this invention to make peoples' lives easier by spending less time traveling, and being able to do other things while traveling besides driving.

In this patent the terms “monorail” and “rail” are synonymous. “dual rail” denotes conventional railroad tracks. The term “road” is not limited to paved surfaces, but can include unpaved surfaces or off-road terrain.

### SUMMARY OF THE INVENTION

A multi-mode transportation system comprised of a transformer vehicle that travels on roads supported by road wheels, or travels on monorails supported by rail wheels, or travels supported by both roads and rails wheels simultaneously. At mount points the vehicles can transition from rail travel to road travel, or from road travel to rail travel.

In a first mode on the road, road wheels support the weight of the vehicle. In a second mode on the monorail, rail wheels support the weight of the vehicle while the vehicle is on the monorail, and side cylinders keep the vehicle upright.

In a third mode, both road wheels and rail wheels support a vehicle's weight using a monorail protruding from the road.

Changing rails, mounting and dismounting are enabled by a plurality of methods including changing travel modes and rotatable monorails.

### DESCRIPTION OF FIGURES

FIG. 1A is a front view of a first vehicle embodiment that has non-pivoting road wheels, non-pivoting rail wheel, and non-pivoting side cylinders.

FIG. 1B is second vehicle embodiment with pivoting side cylinders.

FIG. 1C is a third vehicle embodiment with pivoting road wheels.

FIG. 1D is a fourth vehicle embodiment with a pivoting rail wheel and pivoting side cylinders.

FIG. 1E is a fifth vehicle embodiment with pivoting side cylinders used for mode 3 travel.

FIG. 1F is a sixth vehicle embodiment where a rail wheel can also act as a road wheel

FIG. 1G is a seventh embodiment where an assembly with rail wheel and side cylinders pivots.

FIG. 1H is an eighth vehicle embodiment where the side cylinders plunge down vertically.

FIG. 2A is a monorail mount location top view.

FIG. 2B is a side view of a monorail mount point illustrated in FIG. 2A.

FIG. 2C is a side view 200c of a mount point with a monorail and a road.

FIG. 2D is a side view of a mount point for embodiment 3 vehicles.

FIG. 2E is a set of cross-sectional views from FIG. 2D.

FIG. 3A is a front view of a first embodiment vehicle.

FIG. 3B is a side view of FIG. 3A.

FIG. 4A is a side view of a embodiment 3 vehicle in mode 1.

FIG. 4B is a sectional view of FIG. 4A with vehicle in mode 1.

FIG. 4C is a side view of vehicle in mode 2.

FIG. 4D is a sectional view of FIG. 4C with vehicle in mode 2.

FIG. 4E is a side view of vehicle in mode 3.

FIG. 4F is a sectional view of FIG. 4E with vehicle in mode 3.

FIG. 4G is a sectional view of FIG. 4A with vehicle in mode 1. Tom

FIG. 4H is an illustration of embodiment 3 with a trapezoidal monorail shape.

FIG. 5A is a front view of an embodiment 4 support mechanism in mode 3.

FIG. 5B is a sectional view of FIG. 5A.

FIG. 5C is a front view of an embodiment 5 support mechanism in mode 1.

FIG. 5D is a sectional view of FIG. 5C.

FIG. 6A is a back view of a semi-trailer vehicle operating in mode 3.

FIG. 6B is a side view of a semi-trailer vehicle in mode 3.

FIG. 7A is a perspective drawing of an embodiment 7 support mechanism in mode 1. Tom

FIG. 7B is a perspective view of an embodiment 7 support mechanism in mode 2.

FIG. 8A is a side view of a vehicle using embodiment 6 in mode 2.

FIG. 8B is a top view of a vehicle using embodiment 6 in mode 2.

FIG. 9 is a perspective drawing of a rotatable monorail to allow vehicles to change rails without dismounting.

FIG. 10A is a end view of a monorail crossing point where road traffic can cross paths with monorails at road level.

FIG. 10B is a side view of a monorail crossing point.

FIG. 11A is a cross section view of a monorail with two cylindrical tops.

FIG. 11B is a cross sectional view of an inverted-T monorail.

FIG. 11C is a cross sectional view of a monorail with a side power conductor.

FIG. 11D is a cross sectional view of a monorail with a pair of grip notches.

FIG. 11E is a cross sectional view of an inverted delta monorail.

FIG. 11F is a cross sectional view of a monorail in a letter “Y” shape

FIG. 11G is a cross sectional view of a monorail in a letter “I” shape.

FIG. 12A is side view of a transitional monorail vertical.

FIG. 12B is a side view of a transitional monorail in transition.

FIG. 12C is a side view of a transactional monorail horizontal.

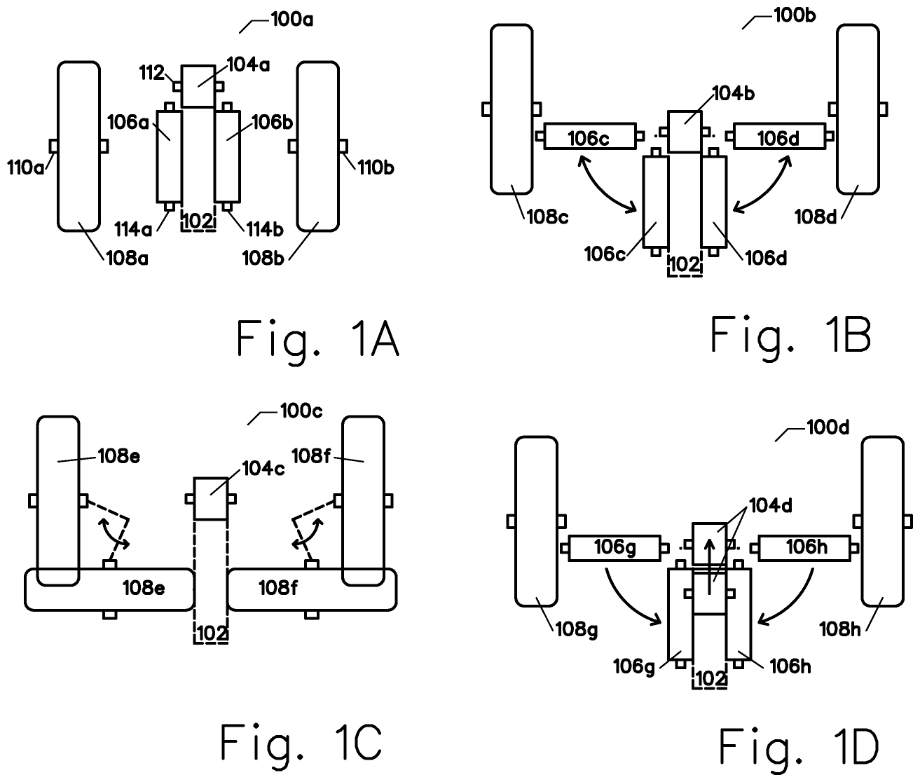

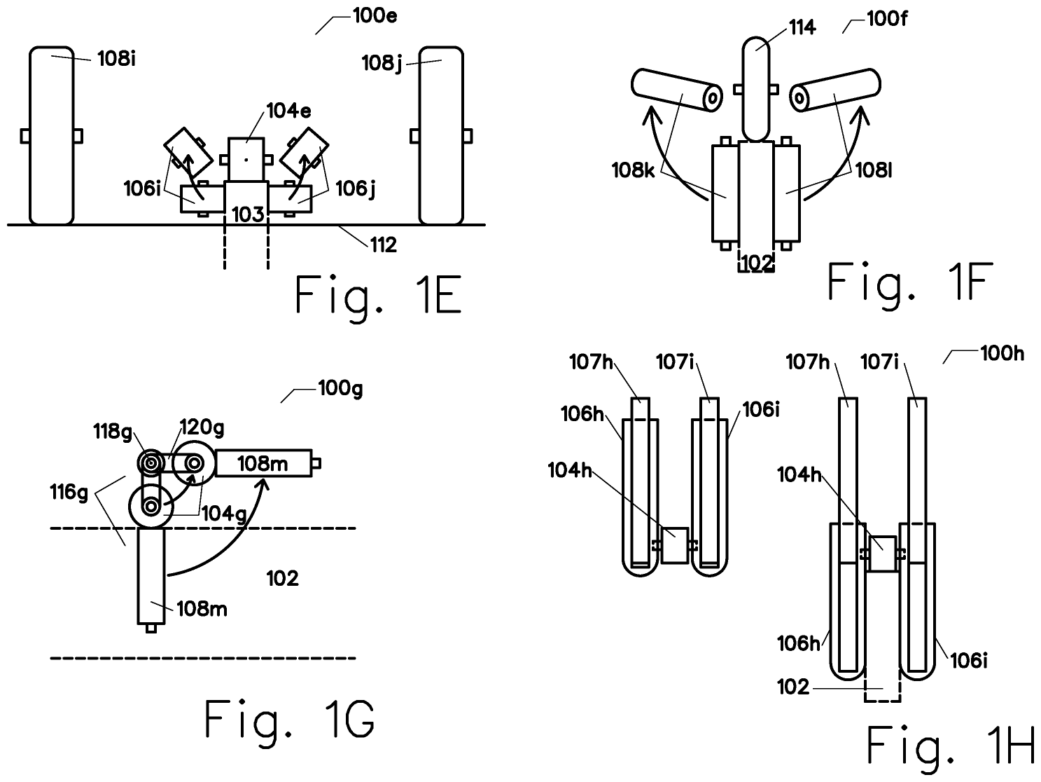

### DESCRIPTIONS FIGS. 1A-1H

FIGS. 1A-1H are different embodiment of support systems fora vehicle featuring relative movement of components. Unless noted, the road is not illustrated.

FIG. 1A is a front view of a first vehicle embodiment 100a that has non-pivoting road wheels 108a and 108b, non-pivoting rail wheel 104a, and non-pivoting side cylinders 106a and 106b. Monorail 102, shown as a dashed line. The wheels spin around their respective axels, 110a, 110b, 112, 114a and 114b. These components remain in a relatively fixed relationship to each other and the frame of a vehicle, allowing for steering and suspension. In mode 2 the side cylinders keep the vehicle from tipping, while the rail wheel(s) supports the weight of the vehicle. In mode 1 the road wheels support the weight of the vehicle.

FIG. 1B is second vehicle embodiment 100b with pivoting side cylinders 106c and 106d. It also features non-pivoting road wheels 108c and 108d, non-pivoting rail wheel 104b, and monorail 102, shown as a dashed line. The wheels spin around their respective axels. In this configuration, the side cylinders 106c and 106d rotate with axels vertical for mode 2 and rotate with axels approximately horizontal for mode 1.

FIG. 1C is a third vehicle embodiment 100c with pivoting road wheels 108e and 108f. It also illustrates a non-pivoting rail wheel 104c, and monorail 102, shown as a dashed line. The wheels spin around their respective axels. In this configuration the road wheels 108e and 108f rotate with axels vertical for mode 2, and with axels approximately horizontal for mode 1.

FIG. 1D is a fourth vehicle embodiment 100d with a pivoting rail wheel 104d and pivoting side cylinders 106g and 106h. Road wheels 108g and 108h are non-pivoting. Monorail 102 is shown as a dashed line. The wheels spin around their respective axels. In this configuration force of the monorail 102 causes the rail wheel 104d to rise, which causes the rail side cylinders 106g and 106h to engage with the monorail's sides. When rail wheel 104d lowers in mode 1, the rails side cylinders 106g and 106h rise to avoid inference with a road.

FIG. 1E is a fifth vehicle embodiment 100e with pivoting side cylinders used for mode 3 travel. A vehicle traveling in mode 3 has road wheels 108i and 108j contacting a road 112. At the same time rail wheel 104e contacts a monorail 103, shown as a dashed line. The monorail 103 has only a portion extending above the road 112. The wheels spin around their respective axels. In this configuration when the rail wheel 104e contacts the top of the monorail, the side cylinders 106i and 106j also contact the sides of the monorail to keep the rail wheel 104e centered. When in mode 1 the side cylinders raise. The side cylinders may be rotated with linear or rotary actuators (not illustrated), and may be electrically, pneumatically, or hydraulically powered.

FIG. 1F is a sixth vehicle embodiment 100f where a rail wheel 114 can also act as a road wheel. A combination wheel 114 is in contact with a monorail 102. While the vehicle is in mode 1 the combination wheel is on the road and side cylinders 108k and 108l are lifted. While the vehicle is in mode 2 the combination road wheel is on the monorail 102 side cylinders are in contact with the sides of the monorail 102. This vehicle in mode 1 could be a bicycle with an ability to get onto the monorail. The side cylinders can pivot straight back relative to the direction of travel, or back at an angle, as illustrated.

FIG. 1G is a seventh embodiment 100g where an assembly 116g with rail wheel 104g and side cylinders 108m and 118n pivots. A side view of a monorail 102 is illustrated. In mode 2 the rail wheel/side cylinder assembly 116g provides a vehicle's support and stability while on the rail. In mode 1 the assembly 116g lifts and rotates to avoid contact with a road. Assembly 116g rotates about a pivot point 118g. The assembly 116g is comprised of a frame 120g, a rail wheel 104g, side cylinders 108m and 108n (not visible) axels, and is in contact with the monorail 102. Road wheels are not illustrated in this figure. In mode 2 the rail wheel 104g is lowered (rotated clockwise) onto the monorail. In mode 1 the assembly 116g is raised (rotated counter-clockwise) to avoid interference with the road.

FIG. 1H is an eighth vehicle embodiment 100h where the side cylinders 106h and 106i plunge down vertically. FIG. 1H illustrates two end views. Mode 1 travel is illustrated in the left view, with side cylinders 106h and 106i raised, and rail wheel 104h not contacting a monorail. Mode 2 travel is illustrated In the right view with the rail wheel 104h contacting top of monorail 102, and the side cylinders 106h and 106i lowered to contact both sides of monorail 102 and provide stability. The side cylinders 106h and 106i are guided by guide pins 107h and 107i. Bearings may be installed in the side cylinders to reduce friction. The bottoms of the side cylinders are illustrated as rounded to facilitate mounting the rail 102.

These 8 embodiments are examples of the possible types of vehicles and vehicle support systems that are anticipated on a monorail/road system. These systems can be mixed, with two, three, four or more road wheeled vehicles possible, with possible different embodiments employed between the front and rear of the vehicles. Additional figures will provide additional details, including rail options, mounting and dismounting options, powering, and rail changing methods.

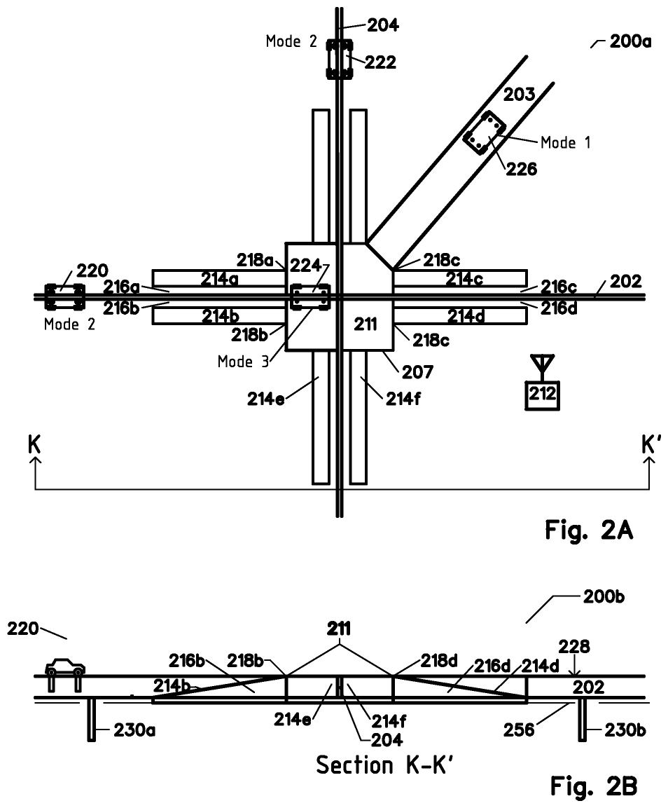

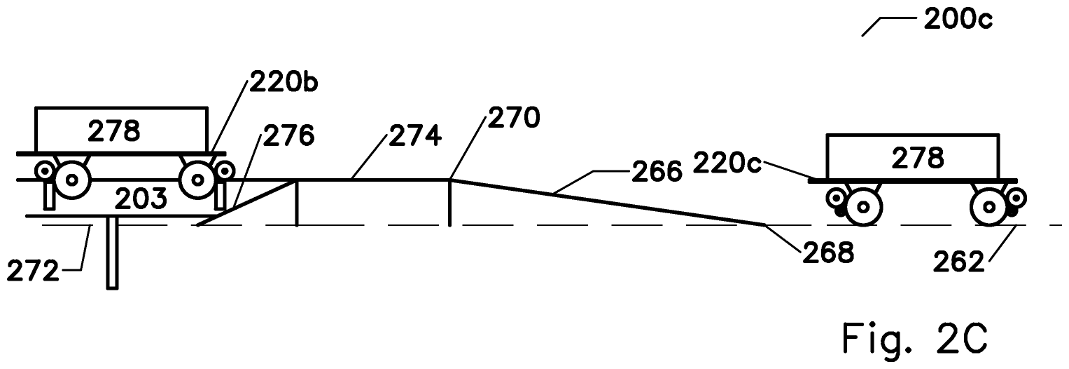

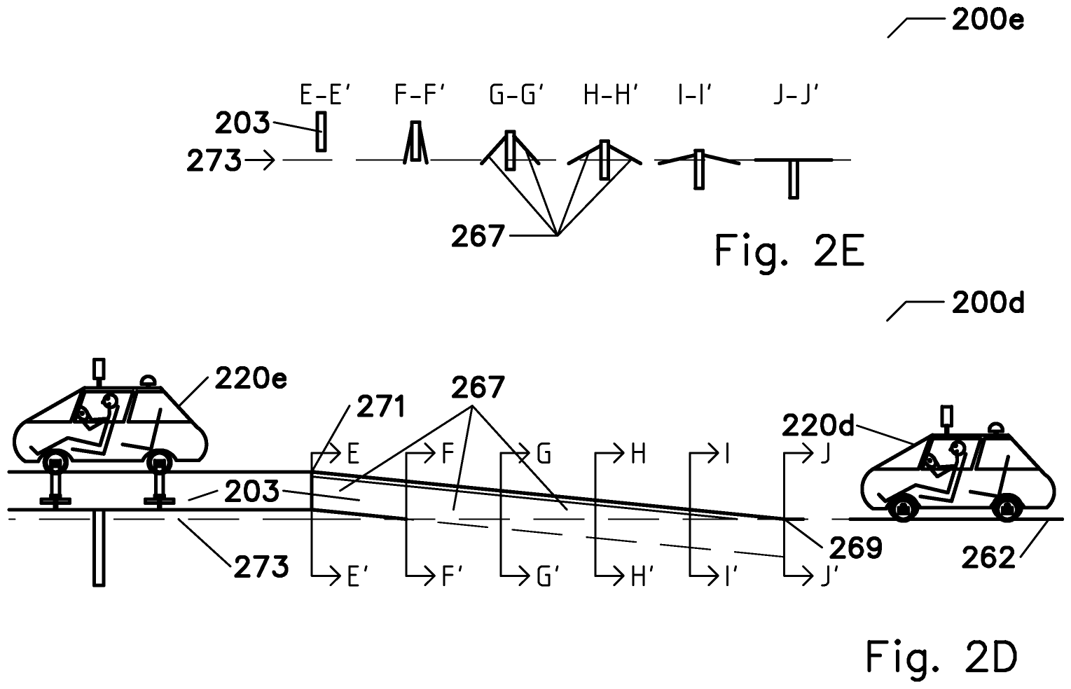

### DESCRIPTIONS FIGS. 2A-2E

FIG. 2A is a monorail mount location top view 200a. It contains an East-West (E-W) orientated monorail 202 crossing a North-South (N-S) orientated monorail 204. The monorails can be rectangular steel beams elevated just above the ground and supported over a structure, such as steel pipes placed into the ground, or other means such as rail-road ties. This design realizes low construction costs relative to conventional roads. In a preferred embodiment, the monorails are hollow inside, and cables for communications, power, or fluids can be placed inside. Alternately infrastructure cables can be placed underground or aerially nearby.

A design of a mount point should take into account the different embodiments used by vehicles that it will be servicing.

Three modes of travel are illustrated in FIGS. 2A-2E. The vehicles in this illustration employ Tom embodiment 2, but other embodiments can use the same rails. A mode 1 vehicle 226 is traveling on a road 203 leading up to a mount point 207. The first vehicle 226 is riding on (rubber) road wheels contacting the road 203. Vehicles in a mode 2, such as mode 2 vehicles 220 and 222, are already traveling on the monorail and have a monorail wheel in contact with the rail. Vehicles in a third mode, such as mode 3 vehicle 224 are passing over a mount platform 211 and have both rail wheels contacting the monorail, and also have the road wheels contacting the top of the concrete (or other) mount platform 211. Travel modes will be explained in subsequent figures.

One function of a mount platform 211 is for vehicles to gain height so they can lower themselves onto monorails. Vehicles mount the monorail as they transition from road travel to monorail travel, and dismount for road travel again at their the end of their monorail travel. Vehicle 226 can mount either E-W or N-S monorail at the mount point 207, which may have a concrete or wooden mount platform 211 elevated above ground level. The mount platform 211, rises from ground level to approximately the same height as the top of the monorails 202 and 204. The monorails 204 and 202 remain substantially flat and level as they traverse the mount platform 211.

An automated system 212 is in wireless communication with the vehicles and is connected to the Internet (or other) system. The automated system may be connected to the Internet by a fiber optic cable located inside the monorail, or use a public or private communication infrastructure. As well as travel control signals, the automated system can also provide data communication services to all vehicles wirelessly, such as Internet access. When given a signal by the automated system 212, the first vehicle 226 mounts the mount platform and aligns itself in the desired direction of travel. As the vehicle travels onto the monorail, it lowers its side cylinders to grasp the sides of the monorail as the vehicle's rail wheels contacts the top of the monorail. Rail wheels, nominally made of steel, provide support for the vehicle while on the monorail, and the side cylinders keep the vehicle upright (stabilized) while on the monorail.

A second vehicle 220 is already traveling on the monorail under computer control, its rail wheels are contacting the monorail, and its side cylinders are lowered to stabilize the vehicle and keep it from tipping. As it approaches the mount point 207, its side cylinders rise up to avoid contact with the ramps 214a and 214b, and then are lowered again as vehicle moves onto ramps 214c and 214d after the vehicle passes the mount point 207. If mounting or dismounting, ramps 214a-214d allow the vehicle's road wheels to lift the rail wheels off of, and back onto the rails. The ramps 214a-214d may extend to the edges of the monorail, or the ramps may use less width to allow a clearance space 216a, 216b, 216c, and 216d to allow easier deployment and retraction of the vehicle's side cylinders.

The automated system's function is to safely maximize traffic flow and reduce travel times. As such, it is anticipated that over a stretch of congested monorail, all vehicles travels at substantially a same speed. An automated system prevents collision with other vehicles under the system's control, or observed by the system. Thus, vehicles may need not stop at monorail intersections or mount points 207. The automated system communicates with a central traffic controller using an Internet (or other) connection and employs sensors such as video cameras, LIDAR, inductive coils for sensing vehicles, and pushbutton switches operated by people wishing to cross. The monorail automated control system may be integrated with a conventional traffic control system.

FIG. 2B is a sectional view K-K′ from FIG. 2A showing a side view of a monorail 202 and an end view of monorail 204. Illustrated are a vehicle 220 in mode 2 which, like the rest of the drawings, is not necessarily to scale. The vehicle 220 is traveling on the monorail to the right. Monorail 202 is supported above ground level 256 by pipes 230a and 230b. Mount platform 211 has a flat surface, and vehicle transition is made from the top of the mount platform onto the monorail over ramps such as ramps 214b and 214d. Ramp 214b starts at mount platform level at point 218b and ends at or near ground level. Likewise, ramp 214d starts horizontally at point 218d and goes down. When a vehicle is dismounting, ramp function is to allow the road wheels to take over support the weight of the vehicle, elevate the rail wheels, and swivel the side cylinders. It is suggested that the ramps have smooth transitions and designed to avoid large instantaneous vertical acceleration. This provides a smoother ride and keeps the vehicle from becoming airborne. The faster vehicles are traveling across the mount point, the longer the ramps regions should be.

Other mount points 207 are considered within the scope of this invention, including T's, Y's, rail intersections, monorail terminations and originations, U-turns, charging stations, wait points, pedestrian pick-up points, etc. Mount points are provided for the smooth and automated flow of traffic. It is also envisioned that a vehicle could be designed to climb onto and off of a monorail from any point on a monorail. Also, vehicles could be designed to only operate in mode 2 on the monorail.

FIG. 2C is a side view 200c of a mount point with a monorail 203 and a road 262. Vehicle 220b, which for illustration purposes is using embodiment 2, is already on the monorail 203 traveling in mode 2 on rail wheels with its side cylinders down for support. Its road wheels are in the air and not contacting anything. Vehicle 220c, in mode 1 with its side cylinders up, is about to mount ramp 266 at point 268. Its rail wheels are in the air and not contacting anything, and its side cylinders are lifted. Vehicle is operating autonomously and does not have an operator. It is transporting a load 278, which may be a car with no monorail capability. The ramp 266 extends from the road 262 at point 268, up to point 270 where ends to make a platform 274. Platform 274 transitions into a down ramp 276 while monorail 203 extends horizontally. As a vehicle transitions from mode 1 to mode 2 its rail wheel first contacts the monorail, and then the side cylinders pivot to stabilize the vehicle on the monorail. Optional clearance spaces on the ramps (illustrated in FIG. 2A) adjacent to the monorails, may be provided to allow side cylinders to drop without hitting the ramp. Ground 272 is below the monorail. Un-mounting the monorail follows an opposite sequence to mounting.

There are many possible alternate monorail mount location designs, with a large number of alternate potential methods for a vehicle to get onto and off of a monorail. Another method would be to have a stopped vehicle on a monorail be picked off of the monorail by forks of a fork lift truck placed under it, and the fork lift truck lifts the vehicle off of the rail and places it onto a road. Alternately an eye bolt or other attachment could be placed on top of the vehicle, and a hook used to pull the vehicle off of the monorail and place it on the ground. An operator could just lift the vehicle on to and off of the monorail if it was light enough.

FIG. 2D is a side view 200d of an alternate mount point for embodiment 3 vehicles. Monorail 203 rises out of road 262. Vehicle 220e is already on the monorail 203 traveling in mode 2. Vehicle 220d, in mode 1, is about to mount monorail at point 269. A tapered ramp 267 extends from the road 262 at point 269, where it is horizontal, to point 271 where it is vertical and merges with the side of the monorail 203. As a vehicle transitions from mode 1 to mode 2 its road wheels go from supporting the vehicle on the road 262 to stabilizing the vehicle on the monorail 203. Ground 273 is below the monorail. Un-mounting the monorail follows an opposite sequence to mounting.

FIG. 2E is a set 200e of cross-sectional views from FIG. 2D. It is comprised of six cross sectional views, E-E′ to J-J′ from FIG. 2D showing the ground level 273, monorails end views such as monorail 203 and taper surfaces, such as taper surfaces 267. As the vehicle moves onto the monorail, the taper surfaces 267 become steeper, as the road wheels drop to support the vehicle. Partway up the ramp a rail wheel contacts the monorail. At section E-E′ the road wheels have vertical axels and are lowered, and at section J-J′ the road wheels have horizontal axes and are contacting the road. As the road wheels rotate, the angle of the road wheel axels should track the taper surface.

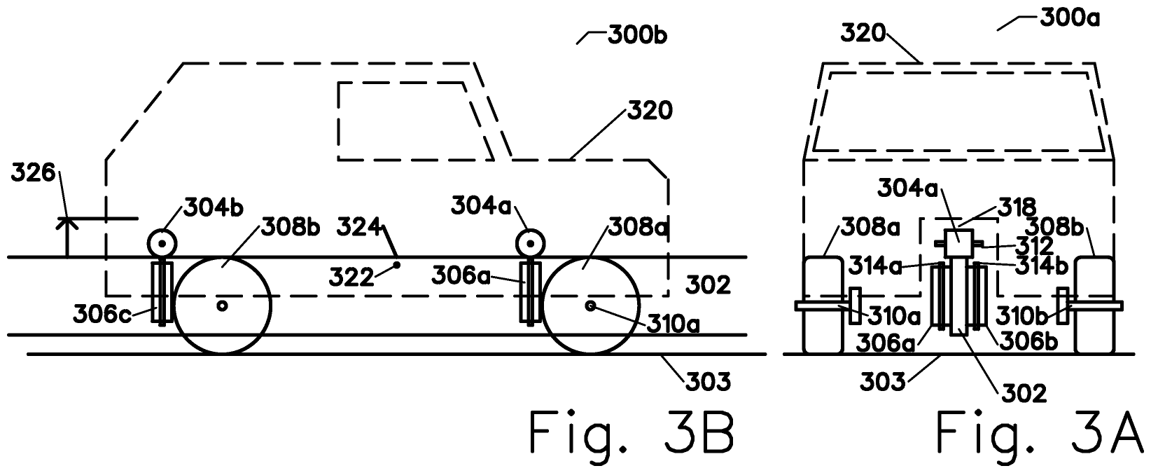

### DESCRIPTIONS FIGS. 3A-3B

FIG. 3A is a front view 300a of a embodiment 1 vehicle. The road wheels, rail wheels and side cylinders remain relatively fixed to the vehicle 320 and are non-pivoting. Both road wheels 308a and 308b, and rail wheel 304a are driven by one or more motors that are not illustrated. Drive at any time may be applied to just road wheels, just rail wheels, or to both simultaneously. Mounting the monorail is accomplished by having a monorail 302 rise out of a road 303 lifting the road wheels off of the road when the rail wheel is supported. Dismounting the monorail is accomplished by having the monorail sink back into the road, lowering the road wheels back to the ground as the rail wheel looses support. Likewise the monorail may remain level, and the road rises or sinks. In mode 2, rail side support cylinders 306a and 306b contact the sides of the monorail and spin around axels 314a and 314b. Ideally the cylinder-to cylinder spacing between the side support cylinders is slightly more than a standardized width of the monorail. If the side cylinders are too tight, there will be high rolling resistance. If the side cylinders are too loose, there will be unwanted sided-to-side instability. However, it may optionally be desirable to make the side cylinder separation distance dynamically adjustable to accommodate a non-standard monorail width. This spacing adjustment feature is also useful when the vehicle is making a sharp turn on a monorail. At monorail mounting points, aligning the monorail between the fixed side cylinders can be facilitated by tapering the width of the monorail at entry and exit points, or by temporarily increasing the spacing between side cylinders 306a and 306b. The mounting structures of the axels 310a, 310b, 312, 314a, 314b to the vehicle's frame are not illustrated.

One possible constraint of the vehicle design of FIGS. 3A and 3B is the intrusion 318 of the rail and support components into the passenger compartment. This may not be a concern if the vehicle is autonomously transporting material, such as grain or water, but is not desirable for humans who may prefer to locate accessories, such as cup holders, low in the middle of the vehicle's passenger compartment. Thus, it is desirable to have the rail support or road support components retractable to reduce or eliminate the intrusion 318, depending on intended vehicle's purpose.

FIG. 3B is a side view 300b of FIG. 3A. The vehicle 320 is shown with both road wheels 308a and 308b in contact with the road 303 and rail wheels 304a and 304b contacting the monorail 302. This condition happens for a short distance while the vehicle 320 is getting onto or off of the monorail. It can also be considered travel in mode 3.

One advantage of the vehicle's design of FIGS. 3A and 3B is the lowered center of vehicle's gravity 322 relative to the top of the monorail 324. If the height of the monorail were increased much further, the intrusion 318 could almost cut the vehicle into two halves. This may not be a problem if the vehicle is transporting freight or material, or if the passengers on the port side and starboard side do not want to communicate with each other.

The vehicle 320 may optionally be height-reduced and fitted with a flat load-bearing roof at height 326 to transport freight such as conventional cars, off-road vehicles, and farm equipment that are not monorail capable.

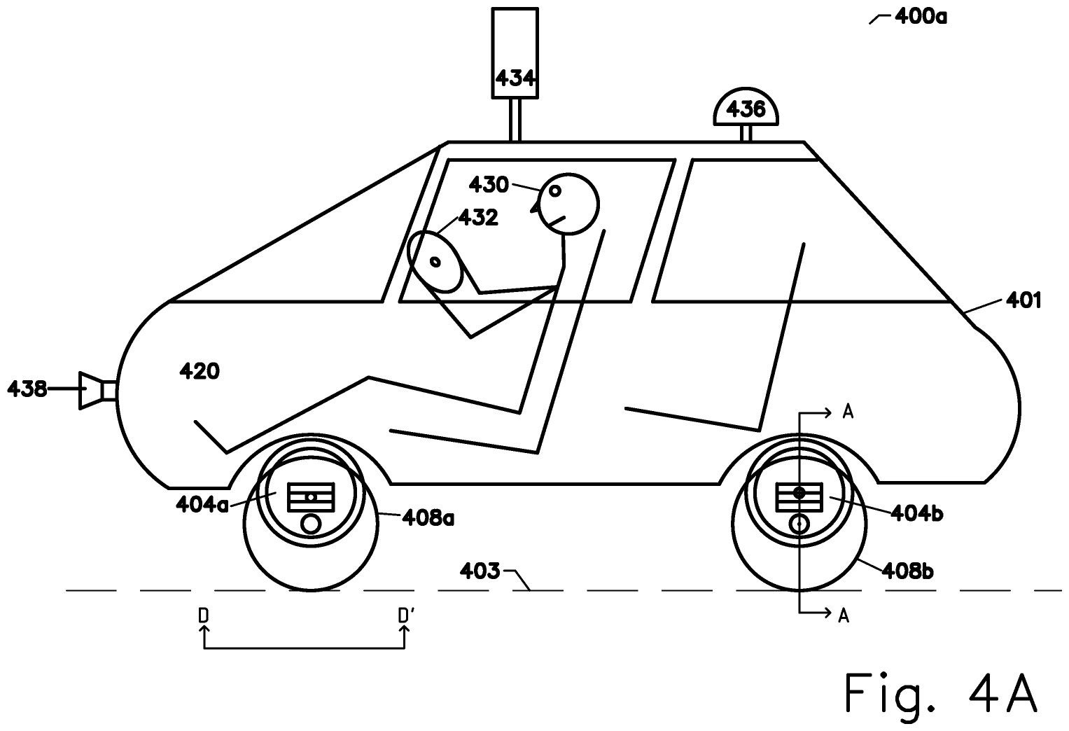

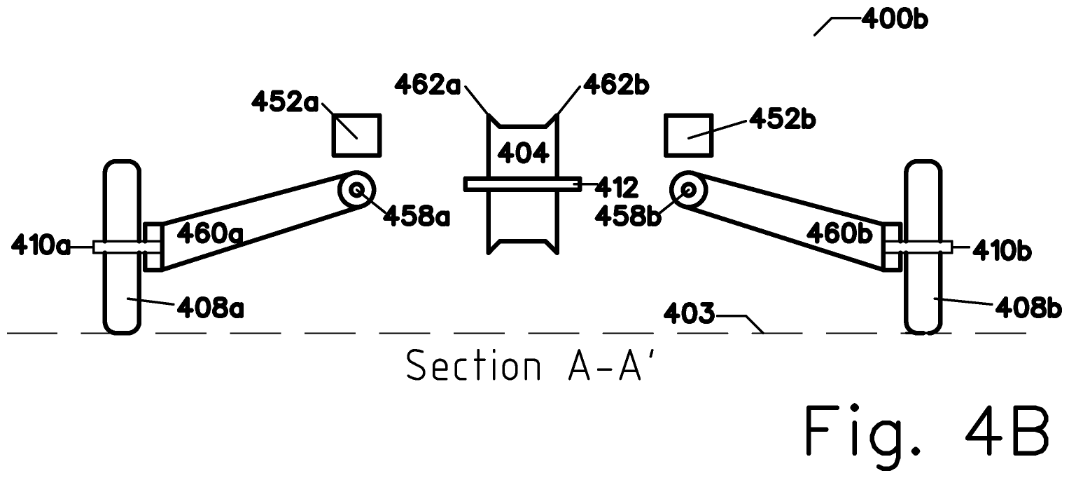

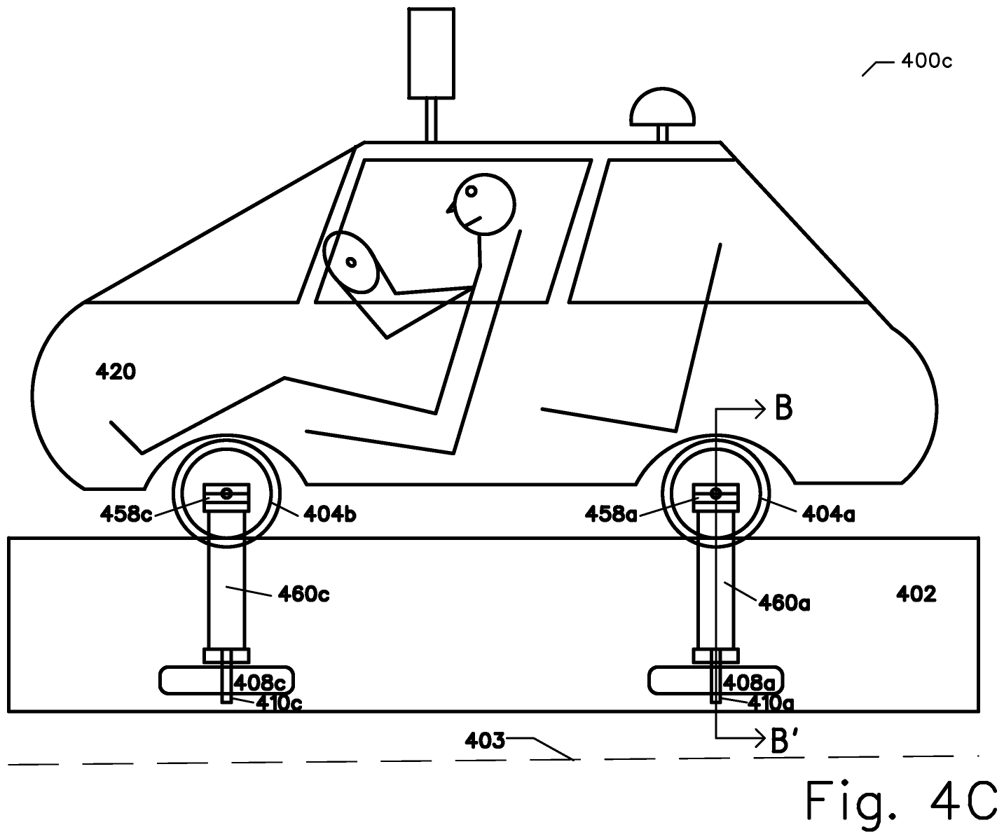

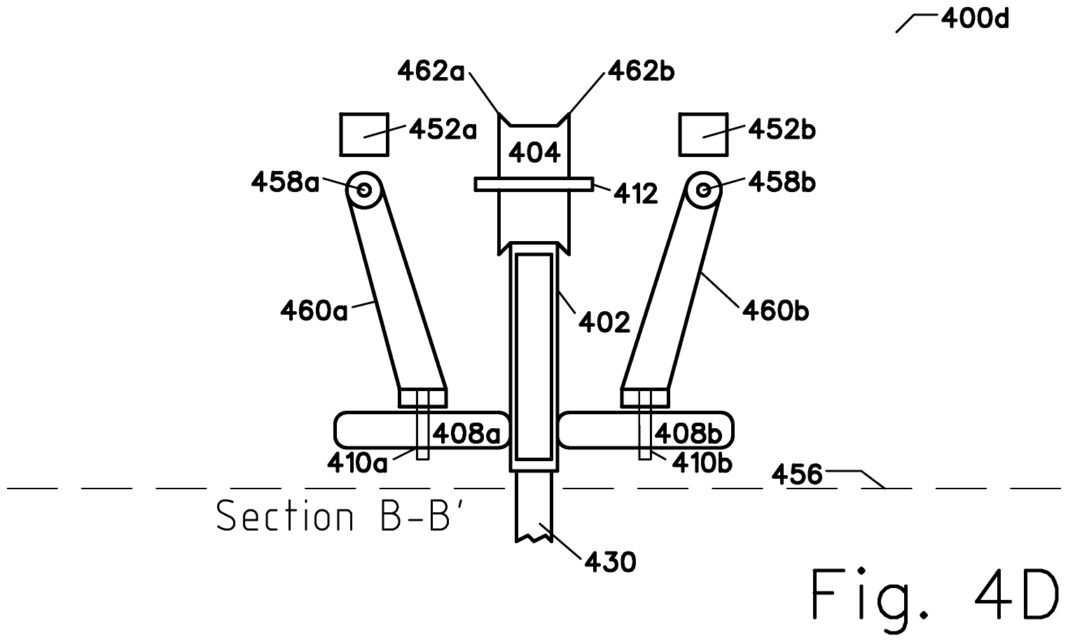

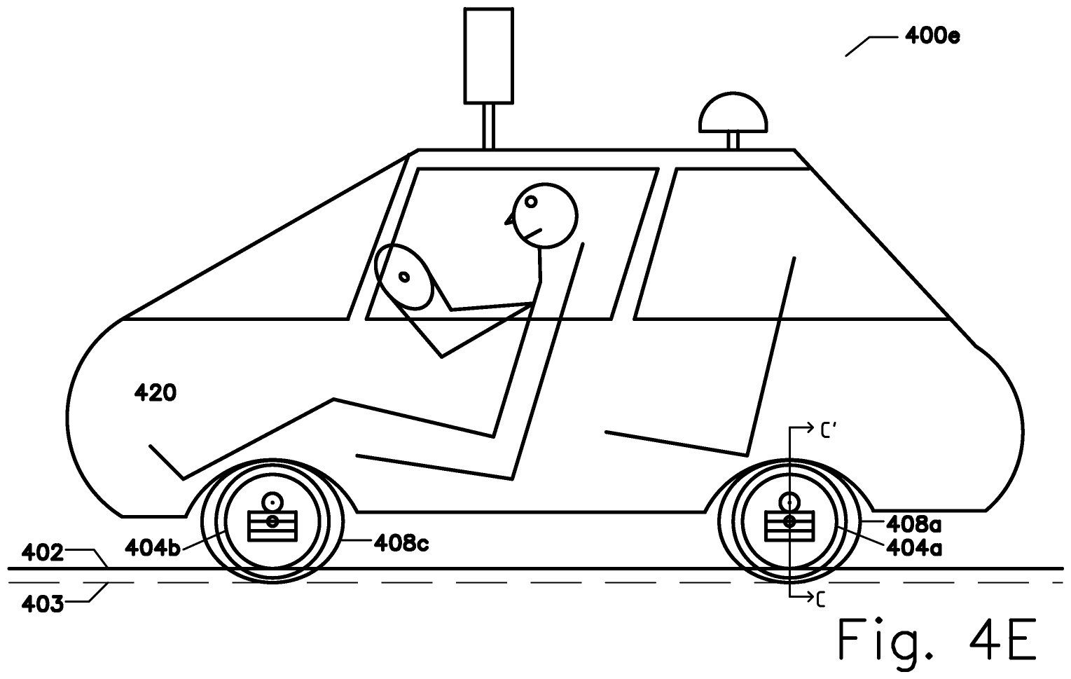

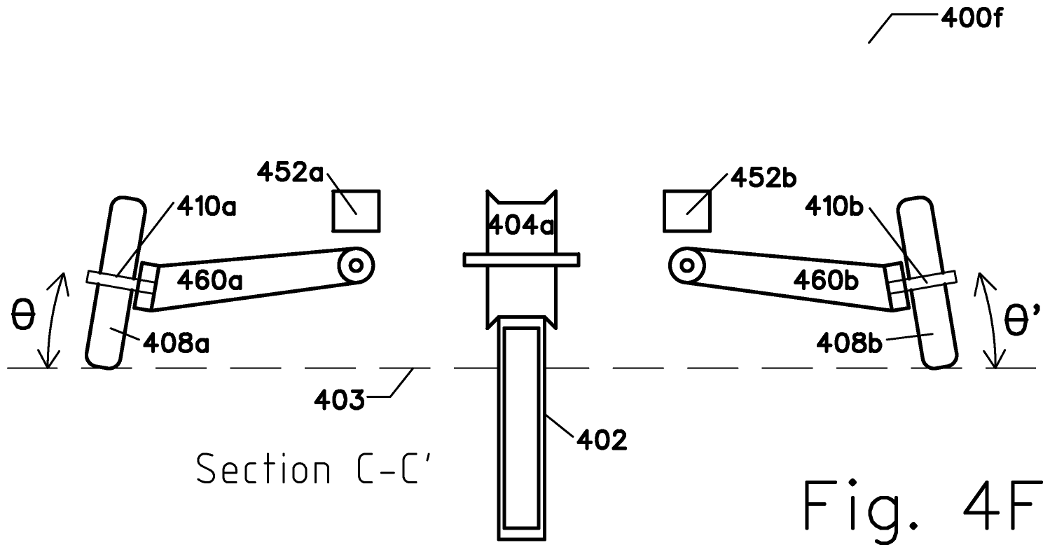

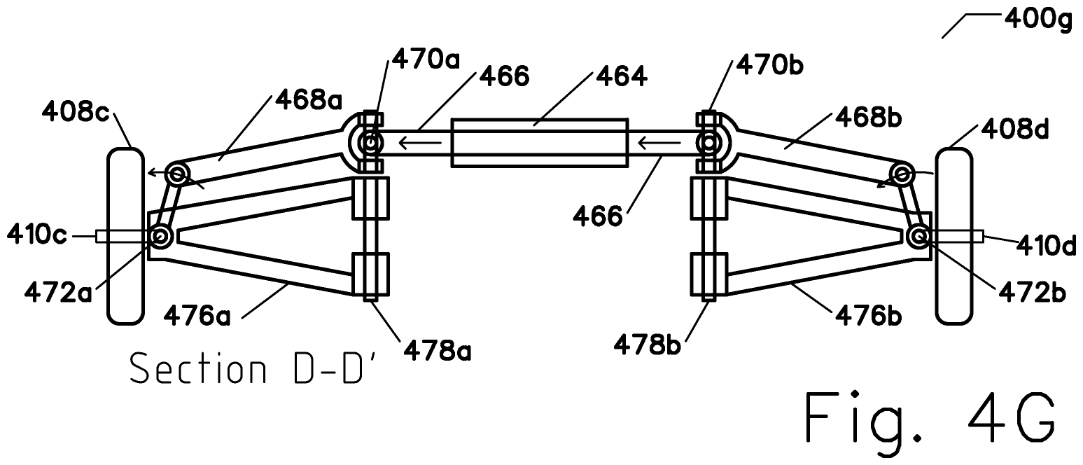

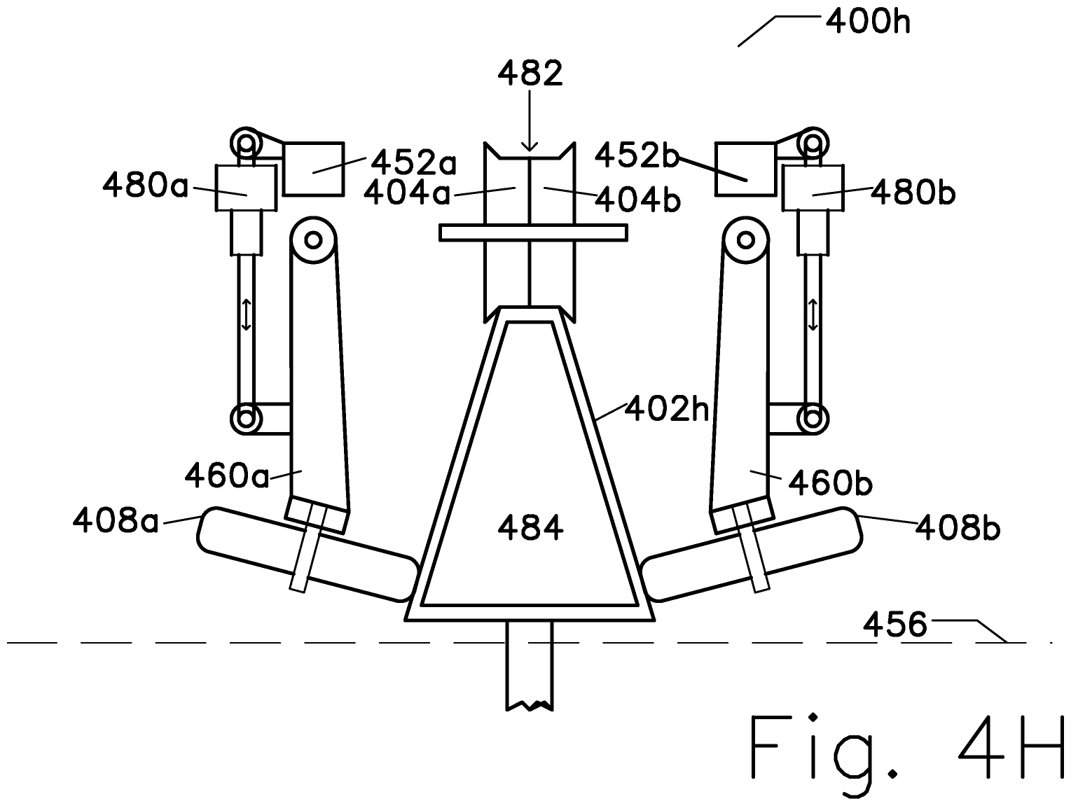

### DESCRIPTIONS FIGS. 4A-4H

FIG. 4A is a side view 400a of a embodiment 3 vehicle in mode 1. This triple-mode capable vehicle 420 is riding on a road 403. The vehicle has four road wheels, such as wheels 408a and 408b which may have pneumatic rubber tires. Road wheels are supporting the weight of the vehicle 420. The vehicle also has two rail wheels, 404a and 404b which are situated above ground between the road wheels. Rail wheels may be steel or alloy metal to reduce rolling resistance. Alternately, they may be made of a hard flexible material designed to reduce noise while rolling on a steel monorail. The vehicle has a body 401 for driver/passenger 430 comfort. A steering wheel 432 allows driver 430 to drive the car when it is not automated or self-driving. The vehicle also has a global positioning system (GPS) antenna and receiver 436 in communication with vehicle computer (not illustrated) for keeping track of vehicle location. The vehicle also has a rotating LIDAR unit 434 for ranging distances to objects. Optional radar 438, which can be CW (continuous wave) or pulsed radar, prevents collisions, both while on the road and on the monorail. Section A-A in FIG. 4B provides an end view of vehicle wheel support components. Section D-D′ in FIG. 4H is a view of steering components.

FIG. 4B is a sectional view 400b of FIG. 4A with vehicle 420 in mode 1. Section A-A′ from FIG. 4A is illustrated. Tom Vehicle's body is supported by frame members 452a and 452b. Vehicle 420 is supported by road wheels 408a and 408b which rotate around road wheel axels 410a and 410b. Axels are connected to swing arms 460a and 460b. Swing arms rotate around swing arm pins 458a and 458b. Swing arm pins are connected to frame members, either directly or through a suspension. The connection is not illustrated for illustration simplicity. Also illustrated is rail wheel 404 capable of rotating around rail wheel axle 412. The rail wheel may be made of steel, and has optional lips 462a and 462b to keep the rail wheel centered over the monorail. Not illustrated is a connection between the rail wheel axel and frame members, either directly or through a suspension. Road wheels 408a and 408b are in contact with road 403. In this illustration the road wheel axels 410a and 410b are situated essentially horizontally.

FIG. 4C is a side view 400c of vehicle 420 in mode 2. The vehicle 420 is mounted on a monorail 402. Rail wheels 404a and 404b are rolling on monorail 402 and support the weight of the vehicle 420. Road wheels 408a and 408c are in contact with the sides of the monorail 402 and stabilizing vehicle 420 and keeping it from tipping. They also guide the vehicle on turns and optionally provide breaking and acceleration. Swing arms 460a and 460c connect the road wheel axels 410a and 410c to the swing arm pins 458a and 458c. In this illustration the road wheel axels are situated substantially vertically. Breaking or acceleration may be applied to either road wheels or rail wheels, but it is anticipated that breaking will be better with road wheels because they are rubber, and they may be squeezed harder onto the monorail when an emergency stop is occurring. As mentioned earlier, in normal operation regenerative breaking is anticipated with energy going to the on-board battery, or returned to the monorail power system, if available.

In this illustration, road wheels are situated in a same plane (relative to direction of travel) with rail wheels, but they may be moved ahead or behind relative to rail wheels. Also 4 road wheels and 2 rail wheels are illustrated, but the numbers of rail wheels and road wheels is arbitrary depending on vehicle's design.

Drive motors can be installed into hubs of one or more road wheels, and optionally into rail wheels, 404a and 404b.

Section B-B′ is a cross-sectional view of the rear wheels. Steering components on the front wheels will be described in FIG. 4H.

FIG. 4D is a sectional view 400d of FIG. 4C with vehicle 420 in mode 2. Section B-B′ is illustrated. The rail wheel 404 is riding on monorail 402. Swing arms 460a and 460b are shown in the lowered position and road wheels have their axels 410a and 410b situated essentially vertically, and road wheels 408a and 408b are in contact with sides of monorail 402. Monorail 402 is supported by support 430 which is planted in the ground and supported by concrete. Supports may be placed every few meters to distribute the load. Ground level 456 is below the monorail to avoid corrosion and allow water drainage. Alternately, for traversing a stream, or going over a highway, the monorail supports can be made longer or held up by a bridge.

FIG. 4E is a side view 400e of vehicle 420 in mode 3. The triple-mode vehicle 420 is in mode 3 and the vehicle has its rail wheels 410a and 410c in contact with a monorail 402, which is partially situated (sunken) in the road 403. The vehicle 420 has its road wheels 408a and 408c also in contact with the road 403. In this third mode vehicle weight is supported by both road wheels and rails wheels simultaneously. Mode 3 is optional. Mode 3 is useful for going smoothly over a mounting point 210 and keeping the vehicle 420 traveling in a straight line, avoiding a jolt for the passengers or any load the vehicle may be transporting. It is also useful for avoiding road damage and achieving energy efficiency while transporting heavy loads. This third mode is accomplished by further lifting road wheels 408a and 408c so that the rail wheels 404b and 404c contact the monorail 402. The top of monorail 402 is essentially several centimeters or more above the surface of the road 403. The monorail's elevation limits the monorail from being covered with gravel or dirt, but is not high enough to impede traffic crossing the monorail at right angles on the road 403. Section C-C′ in FIG. 4F illustrates the situation of wheels while in mode 3.

FIG. 4F is a sectional view 400f of FIG. 4E with vehicle in mode 3. Section C-C′ is illustrated from FIG. 4E. Monorail 402 extends slightly above the surface of road 403, and road wheels 408a and 408b contact the road 403. At the same, time rail wheels, such as rail wheel 404a contact the top of the monorail 402. Swing arms 460a and 460b are retracted (lifted) even further than illustrated in FIG. 4B to allow monorail support of vehicle 420 when passing over a road, or other mounting point. The axels 410a and 410b subtend an angles Θ and Θ′ relative to the road's surface.

A suspension designer of ordinary skill in the art may choose to maintain the axels 410a and 410b more horizontal while in mode 3 for aesthetic or other functional reasons. This can be done by altering the designs of swing arms 460a and 460b.

FIG. 4G is a sectional view 400g of FIG. 4A Tom with vehicle 420 in mode 1. Section D-D′, viewed from below the vehicle, illustrates a steering mechanism used while vehicle is in mode 1. Road wheels 408c and 408d have axels 410c and 410d that are horizontal. Section D-D′ is taken from FIG. 4A and details a modified rack-and-pinion steering mechanism, which is one of many possible steering mechanisms. This mechanism shows a rack housing 464 and a push rod 466. A pinion gear is not illustrated for the sake of illustration simplicity. Tie rods 468a and 468b connect U-joints 470a and 470b to kingpins 472a and 472b. Axels 410c and 410d are rigidly connected to (or are part of) kingpins 472a and 472b. Push rod 466 connects to U-joints 470a and 470b. U-joints are used in place of conventional ball joints to allow swing arms 476a and 476b to drop, allowing road wheels 408a and 408d to contact the sides of the monorail. When the road wheels 408c and 408d are contacting the sides of the monorail, the steering wheel 432 is in a neutral, drive-straight position. Steering is disabled while the vehicle is mounted on the monorail.

FIG. 4H is an illustration 400h of embodiment 3 with a trapezoidal monorail shape. This illustration reveals more features. Monorail 402h has an inverted “V” shaped cross section instead of a rectangular shape. The top and bottom surfaces are parallel to each other, and the left and right surfaces form an angle with respect to each other. This shape is called a trapezoid in some countries and a trapezium in others. This is one of many possible monorail shapes, and this shape may be functionally be created by attaching (welding) steel plates onto conventional railroad tracks. This shape allows the swing arms 460a and 460b to engage the road wheels 408a and 408b onto the monorail sides with less rotation angle. This shape also can accommodate a larger area 484 for infrastructure inside the monorail, such as cables. Another mechanism shown are linear actuators 480a and 480b which push and pulls between attachments on frame 452a and 452b and swing arm 460a and 460b to raise and lower road wheel 408a and 408b. Alternately, a rotary actuator may be used instead of a linear actuator. Also illustrated is a split 482 in rail wheel 404, forming rail wheel halves 404a and 404b. These halves may be spread (or separated) to accommodate a wider monorail top surface.

This pivoting design, with side cylinders replacing the pivoting road wheels 408a and 408b, may be used to enable embodiment 2. Fixed road wheels, such as 108 and 108d are needed in embodiment 2

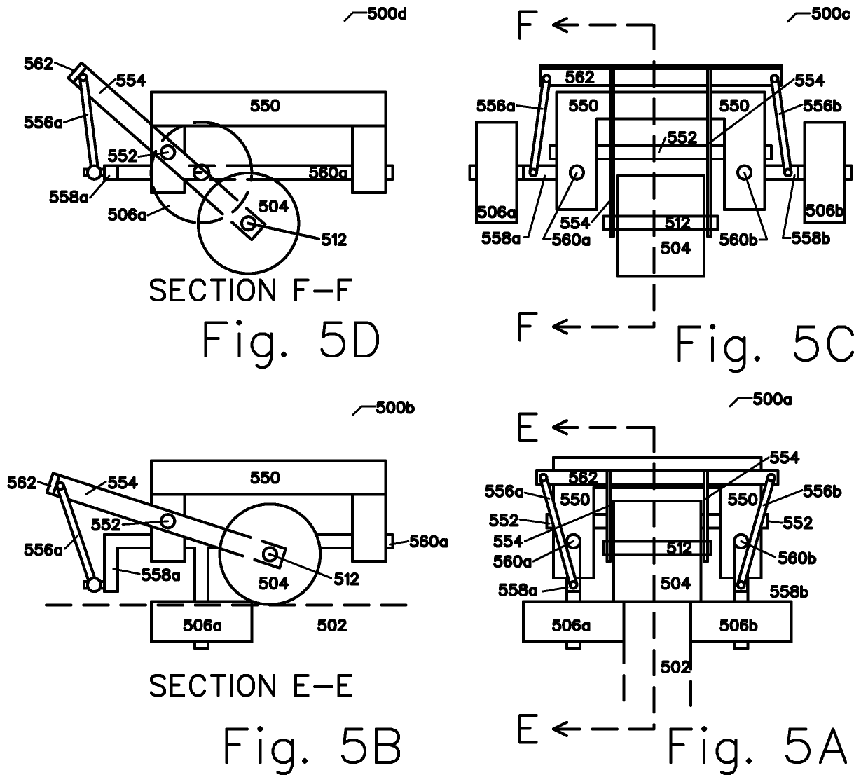

### DESCRIPTIONS FIGS. 5A-5D

FIG. 5A is a front view 500a of an embodiment 4 support mechanism. In this view, the rail wheel 504 is lifted because it is supported by monorail 502. This mechanism has been fitted with short side cylinders 506a and 506b to operate in modes 1 and 3. This mechanism employs an automatic rail-grabber, while is vehicle running on a monorail 502. This embodiment 4 of FIG. 1D causes a rail wheel 504 to automatically stabilize itself centered on a monorail 502 when the rail wheel 504 is pushed up by the monorail 502. The lifting of the rail wheel 504 causes the short side cylinders 506a and 506b to grab the sides of the monorail 502. The short side cylinders 506a and 506b retract when the rail wheel 504 drops because the rail wheel is not supported by the monorail 502. The vehicle's road wheels do not pivot and are not illustrated.

In FIG. 5A the mechanism is supported by frame 550 which holds a pivot shaft 552. The frame 550 is attached to the vehicle, either directly or through a suspension (not illustrated). A first lever 554 has two sides, and supports rail wheel axel 512 in rail wheel 504 from both sides, and pivots around pivot shaft 552. The other ends of the first lever 554 connects to a cross-bar 562 which connects to one end of tie rods 556a and 556b. The other end of the tie rods 556a and 556b connect to side cylinder cranks pins 558a and 558b connected to crank shafts 560a and 560b. The cross-bar 562 pushes on one end of the tie rods 556a and 556b and the other end of the tie rods push on the side cylinder cranks pins 558a and 558b, causing them to rotate. This in turn causes the rail cylinders 506a and 506b to rotate to contact the monorail's sides.

FIG. 5B is a sectional view E-E 500b, of FIG. 5A. Tom Elements are like-numbered.

FIG. 5C is a front view 500c of the rail support mechanism with no support on rail wheel 504. Consequently the rail wheel 504 has dropped, causing the first lever 554 to rotate, lifting cross-bar 562, causing tie rods 556a and 556b to rotate crank pins 558a and 558b, rotating side cylinders 506a and 506b upwards.

FIG. 5D is a sectional view F-F 500d illustrating the rail wheel 504 lowered and side cylinder 506a raised and rotated.

It is good practice to supply a mechanical stop for first lever 554 to prevent excessive force on the monorail 502 when the vehicle is heavily loaded. Excessive side forces causes unnecessary rolling resistance. It is also good practice to lock the rotation of first lever 554 both in mode 1 and mode 2 while the vehicle is moving. This keeps grabbing forces steady when the vehicle encounters bumps

This embodiment 4, illustrated with short side cylinders, works in modes 1 and 3. If the side cylinders were made longer, as illustrated in FIG. 1d FIG. 1D, operation in modes 1 and 2 becomes possible.

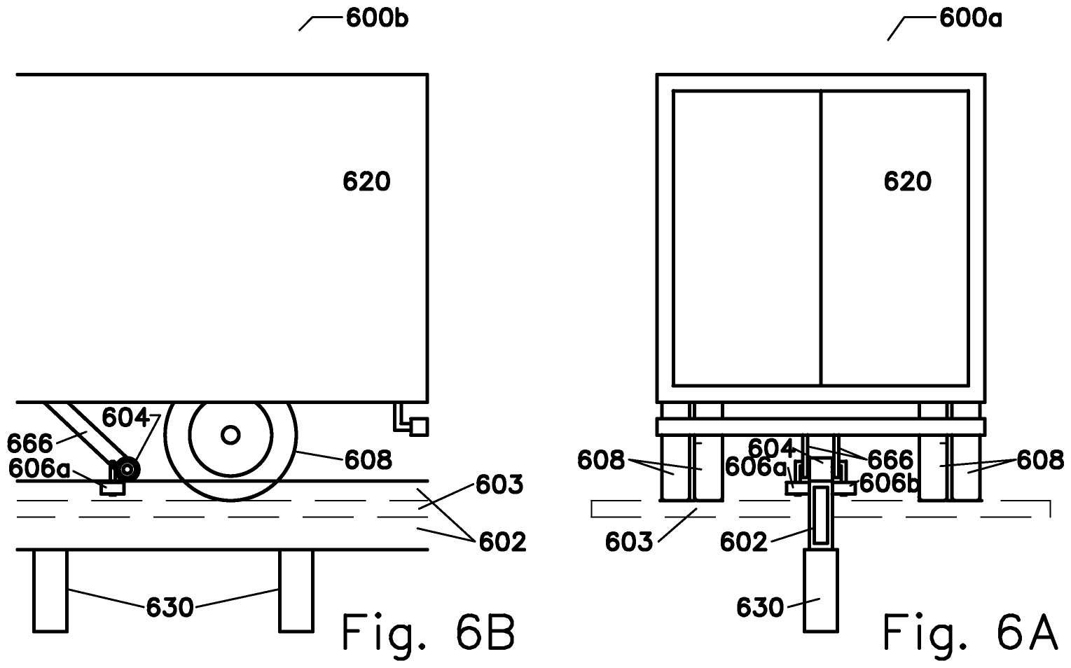

### DESCRIPTIONS FIGS. 6A-6B

FIG. 6A is a back view 600a of a semi-trailer vehicle 620 operating in mode 3. It is an example of embodiment 5 illustrated in FIGS. 5A-5D Tom with road wheels 608 contacting road 603 and rail wheel 604 contacting monorail 602. Side cylinders 606a and 606b keep the rail wheel 604 positioned over the monorail 602. Monorail is supported by support structures 630 which are sunk into the ground. Pivot arm 666 brings the rail wheel 604 down to contact the monorail 602, and brings the rail wheel 604 up when no monorail is present. The advantage of mode 3 is to provide improved fuel economy due to lower rolling resistance. It also avoids damage to road 603, which will break down with repeated stress. Semi-trailer vehicle 620 can also operate in mode 1 by elevating rail wheel 604. Vehicle weight is distributed between road and monorail in mode 3. The monorail 602 extends above road 603 surface. When emergency breaking, pressure on rail wheel 604 is quickly released to give brakes on road wheels 608 more traction by increasing the weight on them. Pivot arm 666 can optionally use air pressure (not illustrated) to maintain constant contact of the rail wheel 604 with the monorail 602. The rail 602 can also be used as an electrical return path for electricity supplied from an overhead wire (not illustrated).

A sensor (not illustrated) on semi-trailer monitors monorail position to lift pivot arm 660 if the semi-trailer vehicle drives off of monorail, preventing road damage. While traveling on monorail, semi-trailer vehicle 602 is preferably being steered by an automated system to keep rail wheel 604 precisely on monorail. Pivot arm 666 should allow the rail wheel 604 to remain on the monorail 602 if the vehicle veers to the left or right, perhaps due to a cross-wind. An automated system may use the monorail, either visually or with sensors, as a guide for automated steering. Should the rail wheel 604 disengage the monorail, pressure on pivot arm 660 should be immediately released to prevent damage to pavement.

The monorail may sink into the ground to facilitate the truck to exit the monorail.

The side cylinders 606a and 606b may be rotated to contact the monorail 602 using the mechanism illustrated in FIGS. 5A-5D, or by actuators.

FIG. 6B is a side view of semi-trailer vehicle 601 illustrating elements shown in FIG. 6A.

Not illustrated are optional brake pads supplied to the vehicle and situated on either side of monorail. The can greatly improve the stopping ability of semi-vehicles.

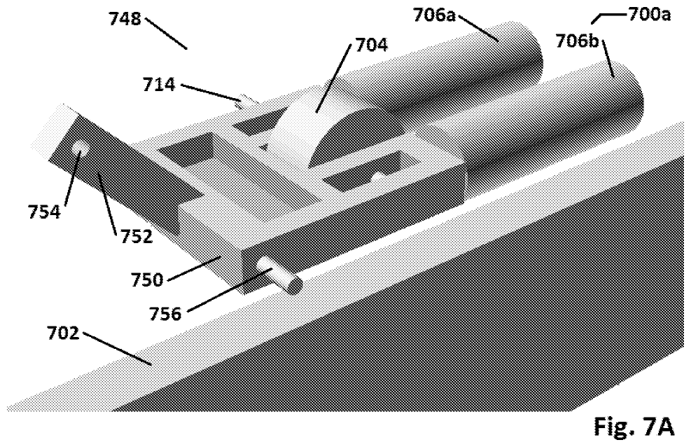

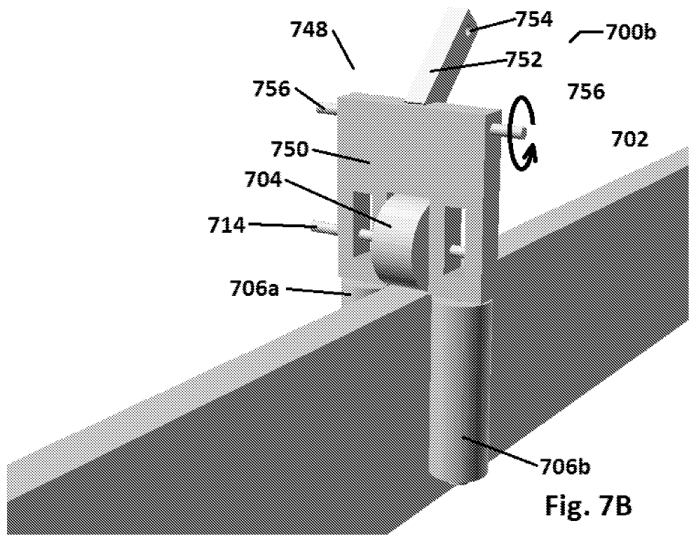

### DESCRIPTIONS FIGS. 7A-7B

FIG. 7A Tom is a perspective drawing 700a of an embodiment 7 support mechanism 748 in mode 1. This mechanism 748 is not shown supporting a vehicle. It consists of a frame 750 to which are attached a rail wheel 704, rail side cylinders 706a and 706b. The mechanism is riding above monorail 702. Rail wheel axel 714 supports the rail wheel 704 and may be driven a motor, which is not illustrated. Frame pivot pin 756 is attached with a bearing (not illustrated) to vehicle's chassis and allows support mechanism to rotate when an actuator pulls or pushes on attachment point 754 on frame arm 752. The actuator may be linear, rotary, or an operator pulling on a lever, not illustrated. Road wheels (not illustrated) are in contact with the road and supporting the vehicle.

FIG. 7B is a perspective view 700b of an embodiment 7 support mechanism 748 in mode 2. By rotating the support mechanism 748 around frame pivot pin 756, the vehicle is lifted onto rail wheel 704 and stabilized by side cylinders 706a and 706b. The support mechanism 748 is rotated about frame pivot pin 756 by pushing or pulling on attachment point 754 on frame arm 752.

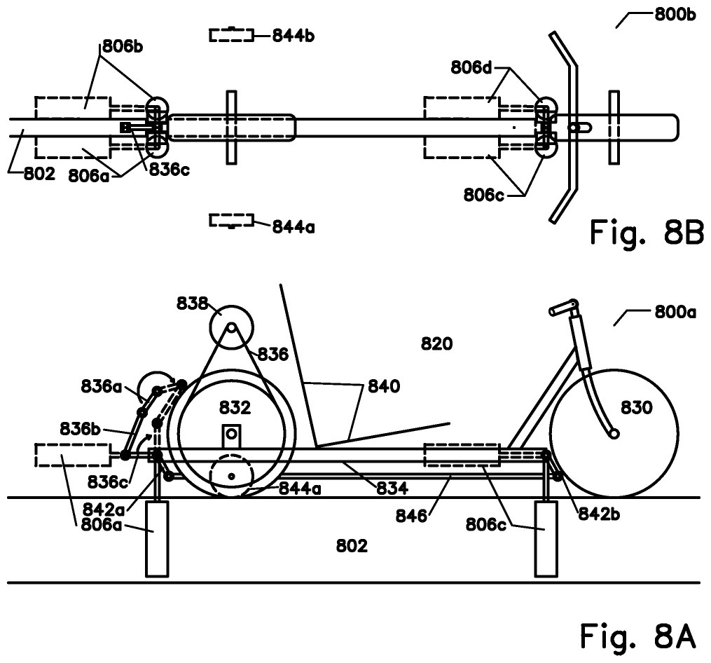

### DESCRIPTION FIGS. 8A-8B

FIG. 8A is a side view 800a of a vehicle 820 using embodiment 6 in mode 2. The vehicle can also operate in mode 1. It is similar to a 2-wheeled recumbent bicycle with a steerable front wheel 830, a rear wheel 832, and a frame 834. The front wheel is steerable while the vehicle is on the road, but locked in a straight position for monorail travel. Both wheels 830 and 832 act as a rail wheels while the vehicle is on a rail 802, and as road wheels while the vehicle is on a road. The rear wheel is belt driven by belt 836, which is driven by motor 838. An optional seat 840 allows for a passenger/driver, or the vehicle can be operated by a traffic control system. Alternately it may transport cargo. Optional training wheels 844a and 844b can hold the vehicle upright when it is not on the rail (not shown attached). Four rail cylinders 806a, 806b, 806c, and 806d support the vehicle 820 on the rail 802 and retract backwards for road travel, shown as dashed line cylinders. The rail cylinders are pivoted by a 4-bar mechanism with input link 836a, coupler 836b, and output link 836c. Link 842a connects link 842b so that when the rear side cylinders rotate, the front cylinders also rotate. They are shown connected by a link rod 846.

FIG. 8B is a top view 800b of a vehicle using embodiment 6 in mode 2. The same objects in FIG. 8A have the same numbers. For drawing clarity, the linkage 846 and 4-bar mechanism components 836a and 836b, motor 838, seat 840, and belt 836 have been omitted. Links 842a and 842b are also not illustrated. The rail cylinders in a retracted position may be directed directly backwards as illustrated, but alternately may be directed backwards at an angle to make mounting the rail easier, as illustrated in FIG. 1F.

### DESCRIPTION FIG. 9

FIG. 9 is a perspective drawing 900a of a rotatable monorail 980 to allow vehicles to change rails without dismounting. This mechanism allows vehicles in mode 2 to change tracks without dismounting or using road wheels. The rotatable monorail 980 pivots around a center pin hole 984. The rotatable monorail is supported from below with bearings, an optional motor, and a center pin (not illustrated). The rotatable monorail 980 connects to 4 rails, 986a from the North, 986b from the South, 986c from the East, and 986d from the West. As a vehicle approaches the rotatable monorail 980, under control from the central traffic control system which knows where the vehicle is going, rotates the rotatable monorail 980, if necessary, to route the vehicle. A 90-degree rotation connects East and West rails. A 45-degree clockwise rotation connects North and West, and South and East. A 45-degree counter-clockwise rotation connects North and East, and South and West. Alternately, the vehicle or operator may request a turn-around (U-turn), and a 180 degree rotation is supplied. The rotatable monorail should have indexed rotation, not allowing it to be misaligned while stationary. Control signals keep vehicles away while the rotatable monorail is in motion.

This rotatable monorail is one of many other possible rotatable monorail embodiments, such as a 3-point interchange or a 5-point interchange. One of the directions, for example, could lead to a dismount location. The rotatable monorail 980 could also be employed to form trains comprised of several vehicles that can be connected or not.

The central traffic control system may group vehicles going to common locations in sequence on the monorail to minimize rotatable monorail turning.

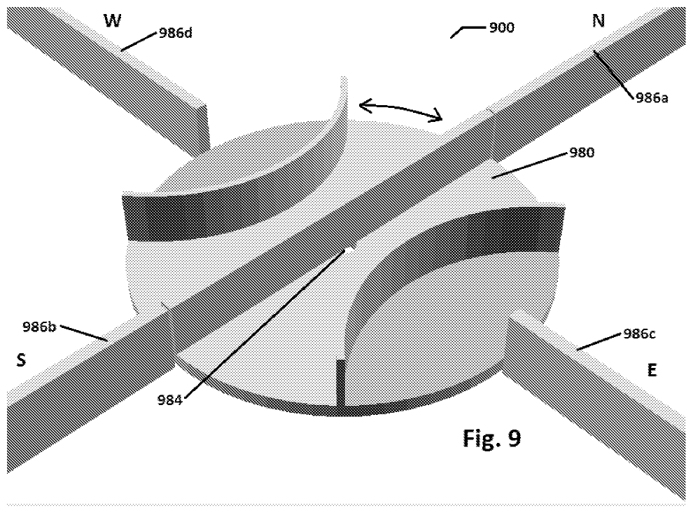

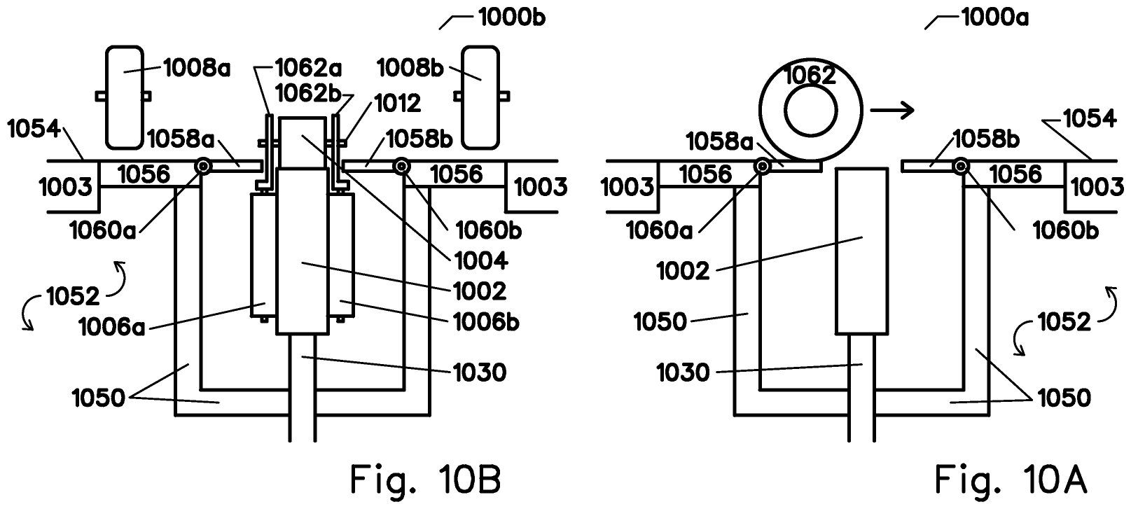

### DESCRIPTIONS FIGS. 10A-10B

FIG. 10A is a end view 1000a of a monorail crossing point where road traffic can cross paths with monorails at road level. Vehicles in mode 2 can pass over highways with overpasses, pass underneath highways with underpasses, or dismount (transition to mode 1) to make a crossing. This is an alternative crossing method. A road 1003 passes at right angles to a monorail's path. Underground a monorail trench liner 1050 is installed with its top contacting an underside of trench top 1056. The trench liner 1050 may be constructed of reinforced concrete and placed in soil 1052. In the trench are a monorail 1002 on a monorail support 1030, which may extend below the bottom of the trench liner 1050. The trench-top 1056 may be made of steel and contains a pair of hinged doors 1058a and 1058b with hinges 1060a and 1060b. A wheel 1062 from a vehicle that could be a conventional vehicle or a multi-mode vehicle is passing over the trench and receives support first from the hinged doors 1058a, then the top of the monorail 1004, then hinged door 1058b.

FIG. 10B is a side view 1000b of a monorail crossing point. Same items have same numbers, but this view shows key portions of a monorail vehicle passing between hinged doors 1058a and 1058b. Illustrated are monorail wheel 1004, monorail axel 1012, and monorail side cylinders 1006a and 1006b. Road wheels 1008a and 1008b are passing above road in mode 1 travel, but may optionally be placed on road for mode 3 travel. Skinny side cylinder supports 1062a and 1062b support side cylinders and are narrow enough to pass between monorail 1002 and hinged doors 1058a and 1058b. Embodiment 7, illustrated in FIG. 7G, could be used for this application.

The crossing can be enhanced to also act as a monorail mount point, with a vehicle in mode 1 making a turn over the monorail crossing to mount monorail 1002 after it passes under the road, and go into mode 2 travel. Monorail 1002 should be extra strong at crossings because it must bear heavy road traffic, such as cement trucks. Hinged doors allow for debris in bottom of tunnel to be periodically cleaned out. The hinged doors should have supports (not illustrated) to keep their tops at ground level. The bottom of the tunnel should have good drainage. Tunnels should not be installed at low ground levels, but the roads should be raised (built up). A sensor (not illustrated) should detect if the tunnel is obstructed, perhaps with water, and signal an alarm to vehicles and the traffic control system. A vehicle's side cylinders can traverse through water, but not at a high speed.

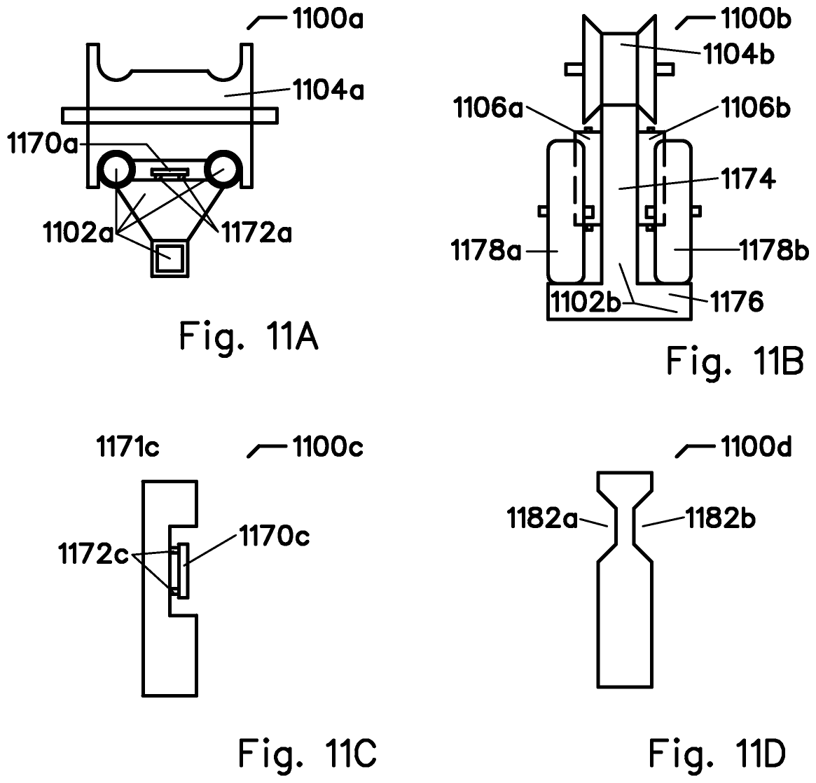

### DESCRIPTIONS FIGS. 11A-11F

FIGS. 11A-11F are cross sectional views of rails designs.

FIG. 11A is a cross section view 1100a of a monorail 1102a with two cylindrical tops, and a rectangular bottom, similar to a roller coaster design, but with an added feature of a top power conductor 170a. Rail wheel 1104a with a rounded contact surface is illustrated, but two rail wheels can also be employed. Unlike roller-coasters, the wheels should be designed to allow the vehicle to dismount and continue in mode 1. The top power conductor 1170a is illustrated, insulated from the monorail by an insulator 1172a. The monorail is used for a return current, and should be grounded. This design can eliminate the side cylinders, provided cylindrical tops are spread apart enough to prevent vehicle tipping.

FIG. 11B is a cross sectional view 1100b of an inverted-T monorail 1102b. Illustrated are rail wheel 1104 and side cylinders 1106a and 1106b. The monorail 1104b has a vertical leg 1174 and a horizontal leg 1176. Lightweight vehicles can use just the vertical leg top and sides for mode 2 travel, but heavyweight vehicles can also use the horizontal leg for additional support, as shown with wheels 1178a and 1178b. As an estimate, a lightweight vehicle could weigh up to 2 tons, and a heavyweight vehicle could weigh up to 20 tons. Thus a same monorail 1102 can carry heavy vehicles, but also accommodate lightweight vehicles.

FIG. 11C is a cross sectional view 1100c of a monorail with a side power conductor 1170c, insulated from the monorail by an insulator 1172c. The power conductor is shown recessed relative to the right side of the monorail 1171c, so that it will not be shorted by a metal side cylinder. Conductors should not sit in water.

FIG. 11D is a cross sectional view 1100d of a monorail with a pair of grip notches 1182a and 1182b that a vehicle can use to hold itself down for conditions where gravity is insufficient, such as strong winds lifting a lightweight vehicle.

FIG. 11E is a cross sectional view 1100e of an inverted delta monorail. It features the grip notches extended over most of the entire side of the monorail. This can be called an “inverted delta” design. It features a wider top surface, spreading out support for rail wheels and reducing stress on side cylinders.

FIG. 11F is a cross sectional view 1100f of a monorail in a letter “Y” shape. The tops of the Y provide spread-out support for monorail wheels, reducing stress on side cylinders. The top sides of the Y provide gripping for side cylinders. A power conductor 1184 can be situated in the middle.

FIG. 11G is a cross sectional view 1100g of a monorail in a letter “I” shape. This has an advantage of being a standard shape carried in steel yards, having a relatively-wide top, and gripping can be done on both the edge and underside of the rail, as illustrated with pivoting 2-wheel rail grabber 1180a, and 1180b. Rail grabber 1180a is illustrated in the grab position, and 1180b is illustrated in the release position.

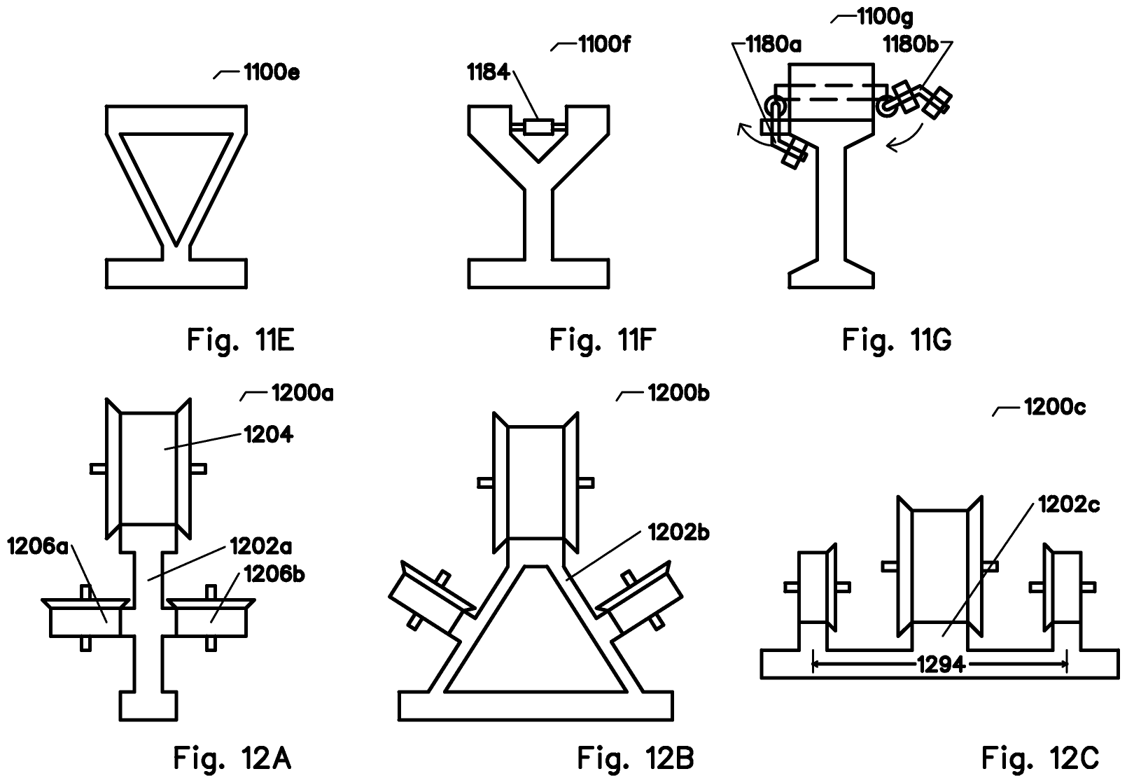

### DESCRIPTIONS FIGS. 12A-12C

FIG. 12A is side view 1200a of a transitional monorail 1202a, vertical. A rail wheel 1204 is on top, and side cylinders 1206a and 1206b grip the sides of the monorail. The side cylinders have lips, and their axels run vertically.

FIG. 12B is a side view 1200b of a transitional monorail, in transition. The side cylinders 1206a and 1206b have pivoted to an angle and sides of monorail 1204b have also pivoted.

FIG. 12C is a side view 1200c of a transitional monorail, horizontal. Further pivoting of the side cylinders has occurred and the axels run horizontally. The monorail 1204c is now essentially flat, and the vehicle can be lifted off of the monorails with road wheels (not illustrated). This rotation is similar to embodiment 3. Note that if the spacing 1294 between side rails is 4 feet, 8.5 inches, this “track” can be used by ordinary United States trains. Alternatively, a transitional monorail vehicle can operate on standard 2-rail train tracks when the monorail wheel 1204 is lifted.

A caveat on this design is that as the monorail transitions from vertical to horizontal, the side cylinders must also match the rotation to avoid either rail “pinching” or instability.

Description of Rail and Track Powering Options

It is a goal of this patent to provide track options for a common system useable by a wide variety of vehicle designers. Standards organizations can standardized track designs for public projects. Inputs into track selection and design must take into account speed of operation, cost, noise, supporting soils, real estate use, environmental, and other concerns.

For safety reasons, it may be advisable to not provide a power surface where animals or humans might accidentally come into contact. For example, power contact surfaces can be removed near road crossings or reserved only for ascending and descending hills. If power contact surfaces supply power for accelerating, they should accept power for deceleration (dynamic braking).

Another embodiment, not illustrated, is a monorail with steel construction on the top and bottom, and a less expensive or lighter-weight material in the middle, such as wood or concrete. Steel with a U-shape is called channel.

These figures all describe cross-sections of monorails. The term monorail is used also when the top of the monorail is split, for example to provide a power contact surface in the middle or a wider stance for off-balanced load.

Model Vehicle Discussion

It is anticipated that there will be an application for scale models or computer models for a variety of uses, including entertainment, training, prototyping, sales, or competition. It is beneficial if all models conform to standardized monorail scales, similar to model 2-track railroad models, as this allows operating vehicles on different track layouts, or competing on a common track. Applicant's prototypes have standardized on a 1-by-4 (19 mm by 89 mm) wooden monorail, where the monorail bottom is elevated 2 cm above the ground. Models can contain one or more cameras for operator vision. The models can be remotely controlled using Radio Control (RC) gear, and may use a standardized cell phone application for control, feedback, and operator vision. Thus, a prospective model purchaser can remotely try out a model before making a purchase. Alternately, a model can exist only in virtual form (computer software), as a video game object. In this virtual game mode, it may or may not be desirable to violate principles of physics.

It is possible to stream videos of competitions, on such platforms as YouTube®. Competitions can be virtual, like a video game, or use scale models, or be full scale.

It is also useful to standardize on power supply voltages and currents if the model rails supply power. 3-D printers allow rapid prototyping of embodiments.

Other Design Features

1. The monorail may be heated for ice and snow removal. This is particularly important for steep grades. Also dedicated snow removal vehicles are anticipated.

2. The monorail may have grooves in the vertical faces to assist steep climbs and descents. This could be compared to a cog railroad used to ascend mountains.

3. One of the important features of the autonomous vehicle is providing Internet connectivity while the passengers are traveling. This can be provided by the automated traffic control system, which may be connected to the Internet. Security, both physical and data, is critical for a transportation system.

4. The rail wheel may be split in the middle, allowing the rail wheel to accommodate wider or narrower monorails.

5. Powering. Since the vehicle must travel over conventional roads, self-power is needed. However, once on the monorail, rolling resistance is reduced and range is extended. Since the monorail is expected to be made with metal, it can act as a ground return for electricity supplied either overhead or as part of the monorail. Likewise, rapid battery charging can be done by power cables inside the monorail.

6. Drive motors may be located in hubs of road wheels e.g. 308/408 and or in the rail wheels e.g. 704.

7. Brakes may be located in the hubs of wheels 308/408. Ideally regenerative breaking is used except in emergency situations. During breaking or acceleration, the road wheels in mode 2 can grip the monorail more tightly, providing better traction. While cruising, road wheels can provide a looser grip for lower rolling resistance and more fuel economy. Vehicle brake pads can be situated to either side of monorail, providing very fast emergency stopping. Seatbelts are advised for passengers.

8. Suspension. Illustrated is stiff suspension, but spring suspensions are anticipated for both the rail wheels and road wheels for passenger comfort or a smoother ride if the vehicle is carrying freight.

9. Other modes anticipated are monorail to water, or monorail to air.

10. Road wheels can be pre-lifted to avoid a jolt at a mount point or crossing, or a merge location. Likewise dampening of wheels can be adjustable. Dampening fluid which changes viscosity when a magnetic field is applied is available. An adjustable suspension will also allow for weight re-distribution as vehicle load varies and as road conditions vary. This will keep the load balanced over the monorail.

11. Vehicle can form a train by coupling. This reduces wind resistance. An engine can be used to pull or push a number of vehicles, which may be coupled.

12. Vehicles can tow a trailer, which can also mount the monorail. The trailer may transport anything now being transported by conventional trailers.

13. Steering on the road can be done by pivoting the vehicle's frame. This steering is accomplished with two fixed axels, and a pivot point, similar to a wagon. This type of steering is called articulated steering. Articulated steering can also be controlled by speeding up or slowing down one wheel relative to the other. This is particularly easy when the wheels are controlled by stepper motors. That is, no steering wheel is needed, and steering is accomplished by motor relative speed control.

14. Dual monorails can allow for passing, bidirectional traffic, or service vehicles. In remote areas, a single monorail can accommodate bi-directional traffic rail using sidings, with switching automatically controlled.

15. A automated vehicles can generate revenue from other travelers while commuter is at his destination. This also avoids parking fees.

16. The mode 3 may be used by conventional traffic on conventional roads modified with a monorail in the middle of each lane. This is done to provide lower rolling resistance, with the monorail's top extending slightly above the road. This mode may also be used by heavy vehicles to prevent road damage. As a design consideration, a monorail's foundation preferably is made independent of the road's foundation, as a steel monorail will flex under a heavy load, but concrete cannot flex and will crack.

17. A vehicle can be powered by any power source, including but not limited to fossil fuel, batteries, electricity from an overhead wire, electricity from the monorail, batteries, a sail on the vehicle, solar panels on the vehicle, or human or animal power.

18. When rail wheel contacts monorail, a sensor switch can automatically cause the rail cylinders to descend and grab the monorail, and when the rail wheel lifts off of monorail, rail cylinders can automatically release the monorail and retract.

19. Conventional monorail track changing mechanisms are anticipated and may be used as part of this system. Conventional monorail track changers have a section of track that pivots on one end and the other end switches between 2 or more tracks. If this mechanism is used, switching can be minimized by grouping together vehicles that are traveling on a same monorail.

20. Monorail tops may tilt into a turn to compensate for centrifugal forces on vehicle. This relieves forces on rail cylinders, and on road wheels that are contacting the monorail. Alternately, on sharp turns, monorails may reduce width to decrease side cylinder force, or “pinching”.

21. Another anticipated system is the toy market with scaled-down vehicles and mount platforms. This is also an effective method to demonstrate the vehicles' abilities, particularly under computer control.

22. Rails may be considered to be structural trusses, and made less expensive with construction using steel strips, or channel, on the top and bottom, and a wood lattice (members) in between top and bottom steel strips.

23. The vehicles can have flat tops, or truck beds on top and be used to transport cargo, which can include vehicles unable to self-drive on monorails. The monorail may be deployed in tunnels, mine shafts, on the sides of buildings, or over rivers with bridges or pontoons. If the span is not excessive, the fact that the monorail is a truss can be used to reduce the number of support points.

24. Road use also includes all types of road, and includes off-road terrain.

25. Side cylinders height may vary. If the height is short, they resemble wheels. Side cylinders may also have non-uniform diameter, perhaps to reduce weight, avoid shorting a power conductor, or limit contact area with the sides of a monorail.

26. Anticipated are pairs of monorails for bi-directional traffic. However, for lightly traveled regions, a single rail can be used, with rail siding to allowing vehicles to pass. If a pair of monorails is spaced the same everywhere, both monorails can be used at the same time to make a conventional 2-track rail system, spaced 4′-8.5″ in the United States.

27. Trains could operate over this system on a scheduled basis, for example in the early morning for supplying businesses and restaurants.

28. Load shifting at right angles to the direction of travel allows the vehicle to be in balance on a monorail. Examples of the load being shifted may be fuel, cargo, batteries, a dummy load, or passengers. Load shifting may be used on changes in the direction of travel to minimize side forces on the monorail.

29. Because high speed is anticipated, retractable wheel may be used to reduce wind resistance. The equivalent in aircraft technology is retractable landing gear.

30. Because of low rolling resistance and vertical stability, a vehicle can be equipped with a sail to move the vehicle. This could be particularly entertaining on a beach with prevailing off-shore winds. A monorail is provides a similar function to a sailboat's keel.

31. The vehicle may employ brake shoes on both side of the monorail for fast stopping, such as in an emergency. Normally regenerative braking in anticipated.

32. For safety, it is important to keep a vehicle's rail wheel in contact with the monorail while in mode 2. Should contact be lost for some reason, a magnetic field can be activated to pull the rail wheel back down to the monorail, assuming the monorail is magnetic.

33. For even lower friction than a monorail wheel provides, air pressure between the bottom of the vehicle and the top of the monorail can be used (ground effect). Air can be contained with a curtain, greatly reducing airflow.

34. The ends of the side cylinders can be fitted with a road wheels. Alternately, side cylinders can be fitted to the undersides of swing arms 460. To reduce rolling resistance, monorails can be designed to contact the side cylinders and have clearance for road wheels. This would by a hybrid design between embodiments 2 and 3.

What I claim is:

1. A vehicle traveling on a road with a road wheel contacting the road and with a rail wheel elevated above the road, and said vehicle traveling at a different time on a monorail with the rail wheel contacting the top of the monorail and with the road wheel contacting the side of the monorail.

2. A vehicle according to claim 1 wherein the road wheel pivots from having a substantially horizontal axel to having a substantially vertical axel.

3. A vehicle traveling on a road with a road wheel contacting the road and with a rail wheel elevated above the road, and said vehicle traveling at a different time on a monorail with the rail wheel contacting the monorail, the road wheel elevated above the road, and a side cylinder contacting a side of the monorail.

4. A vehicle according to claim 3 where the side cylinders pivot.

5. A vehicle according to claim 3 wherein the road wheels, rail wheels and side cylinder do not pivot on the vehicle.

6. A vehicle according to claim 3 where the rail wheel and the side cylinder are connected and pivot together.

7. A vehicle traveling on a road with a sunken monorail with a road wheel contacting the road and a rail wheel contacting the monorail, where the both the rail wheel and the road wheel support the vehicle.
